(19) United States
(12) Patent Application Publication
(10) Pub. No.: US 2010/0180127 A1
(43) Pub. Date: Jul. 15, 2010

(54) BIOMETRIC AUTHENTICATION BASED UPON USAGE HISTORY

(75) Inventors: YUK L. LI, COLONIA, NJ (US); PADMAJA RAMADAS, DAVIE, FL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/342,621

(22) Filed: Jan. 14, 2009

(51) Int. Cl. H04L 9/00

(52) U.S. Cl. 713/186

(57) ABSTRACT

Customized biometric authentication based at least in part upon usage history and learning capabilities of a user is provided. A biometric sample of a user received at a biometric interface of a device is compared with at least one stored template that uniquely identifies the user, and a match score generated when the biometric sample matches one of the stored templates. The match score is compared to a match score threshold value of an application that the user is attempting to access to generate match score comparison results, and an updated false reject ratio (FRR) for the last N matches of the user is calculated. The user is allowed to access the application when the match score comparison results indicate that the match score is at least equal to the match score threshold value and the updated FRR is less than a FRR threshold value of the application.

### CROSS-REFERENCE TO RELATED APPLICATIONS

The present application is related to the following U.S. application commonly owned together with this application by Motorola, Inc.:

Ser. No. ______, filed ______, 2008, titled “CONTEXT AWARE BIOMETRIC AUTHENTICATION”, Li, et al. (attorney docket no. CS35580), on even date herewith.

### TECHNICAL FIELD

The technical field relates generally to biometrics and more particularly to biometric authentication requiring user training and on-going usage.

### BACKGROUND

For devices having a biometric sensor security capability, the ability to determine whether a match of sufficient quality has been obtained between a biometric sample provided by a user and a user template is important. The accuracy of the biometric sensor, which may be affected by such factors as the placement of the sensor and the way in which a user interacts with the sensor to provide biometric samples, as well as the quality of the algorithms used to manage the biometric authentication process are considerations for quality biometric authentication.

User learning is needed for the user to provide biometric samples of sufficient quality to the biometric sensor. A well-designed, ergonomic system helps users learn to provide biometric samples of sufficient quality. Most users when first learning the mechanics of proper sampling, however, will initially perform poorly, with high failure rates. This unfortunately results in user frustration that causes some users to forgo the biometric feature altogether. User frustration will be even greater in applications typically requiring higher levels of security and thus higher accuracy in the biometric authentication process, such as banking, e-commerce and financial transactions.

Consider a product device having a biometric fingerprint sensor for biometric authentication. Upon receiving the product, the user is guided to enroll his fingerprint and then asked to verify the enrollment. Once verified, the biometric fingerprint scan feature of the device is activated. Now, suppose the user decides to use this feature for an e-commerce transaction, and biometric authentication of the user fails for this application because the user did not learn to use the fingerprint sensor properly. Unless the user can readily learn how to use the fingerprint sensor, frustration may cause the user to disable the biometric authentication function altogether.

Thus, there exists a need for biometric authentication that minimizes user frustration with the biometric authorization process, thereby addressing at least some of the shortcomings of past and present biometric authentication techniques and/or mechanisms.

### BRIEF DESCRIPTION OF THE FIGURES

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1 is a functional diagram of a device capable of biometric authentication, in accordance with various embodiments.

FIG. 2 illustrates a biometric interface and an authentication interface of a device, in accordance with various embodiments

FIG. 3 is a flow diagram illustrating a method of biometric authentication, in accordance with various embodiments.

FIG. 4 is a flow diagram illustrating a method of biometric authentication, in accordance with various embodiments.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. It will be further appreciated that certain actions and/or steps may be described or depicted in a particular order of occurrence while those skilled in the art will understand that such specificity with respect to sequence is not actually required. Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

### DETAILED DESCRIPTION

Generally speaking, pursuant to the various embodiments, customized biometric authentication for a user is provided based at least in part on the usage history and learning capabilities of the user. This customized biometric authentication teaches the user to submit improved biometric samples in order to eventually achieve a good sample quality, updates a false rejection ratio (FRR) of the user as biometric samples are submitted, and provides the user with an alternative authentication method when the user's match score is not yet equal to a match score threshold value. Those skilled in the art will realize that the above recognized advantages and other advantages described herein are merely illustrative and are not meant to be a complete rendering of all of the advantages of the various embodiments.

For devices with biometric security capability, the accuracy of the sensor, defined by false accept ratio (FAR) and false reject ratio (FRR), and supporting authentication algorithms is a concern. Of particular concern is training the user on proper mechanics of biometric sampling and the effect that such training has on the accuracy of the biometric authentication process as well as on the user experience.

In a study undertaken by applicants with an ergonomically designed fingerprint sensor system and with extensive user training on proper biometric fingerprint sampling, it was found that the accuracy of the device system was FRR=3.6% at an FAR=0.001%. By eliminating inconsistent user presentation of the biometric samples, such as bad fingerprint swipes even after user training on proper swipe techniques, accuracy improved to FRR=1.26@FAR=0.001%. The accuracy of different sample mechanics was explored. It was found for example that the user performed very poor fingerprint swipes if no instructions were provided for proper sensor swipe techniques. It was additionally found that a “blind swipe” sample, in which the user cannot see the sensor itself, is of inferior quality to a “visual swipe” sample and is thus more difficult for the user to provide, for example. It was noted, however, that the user became extensively frustrated by the training process and that the achievable accuracy level was dependent on the user's experience with biometric authentication. Some users took longer to learn and some took less time. Moreover, it was discovered that the characteristics of the user, such as the size of the hand, large versus small, also impacted the learning process and effectiveness.

With a well-designed, ergonomic system and with limited user training, most users will take time to learn the correct swipe mechanics to provide acceptable performance for biometric authentication. Many users will initially perform poor swipes, causing high failure rates (FRR) of more than 10%. This, unfortunately, results in user frustration that causes some users to forgo the biometric feature altogether. User frustration will be even greater in applications typically requiring higher levels of security and thus higher accuracy in the biometric authentication process, such as banking, e-commerce and financial transactions.

The matching algorithm of a biometric authentication feature has a match threshold that can be set. The threshold can be set depending on the appropriate FRR and FAR for a particular application. Lowering the threshold results in a lower FRR that is more tolerant of bad biometric samples, such as from bad fingerprint swipes, but also results in a higher FAR that provides less security against imposter matches. Usually because of user frustration level, the match threshold is set to the lowest acceptable threshold. However, such a low threshold may not be sufficient for high security applications such as financial transactions and government applications.

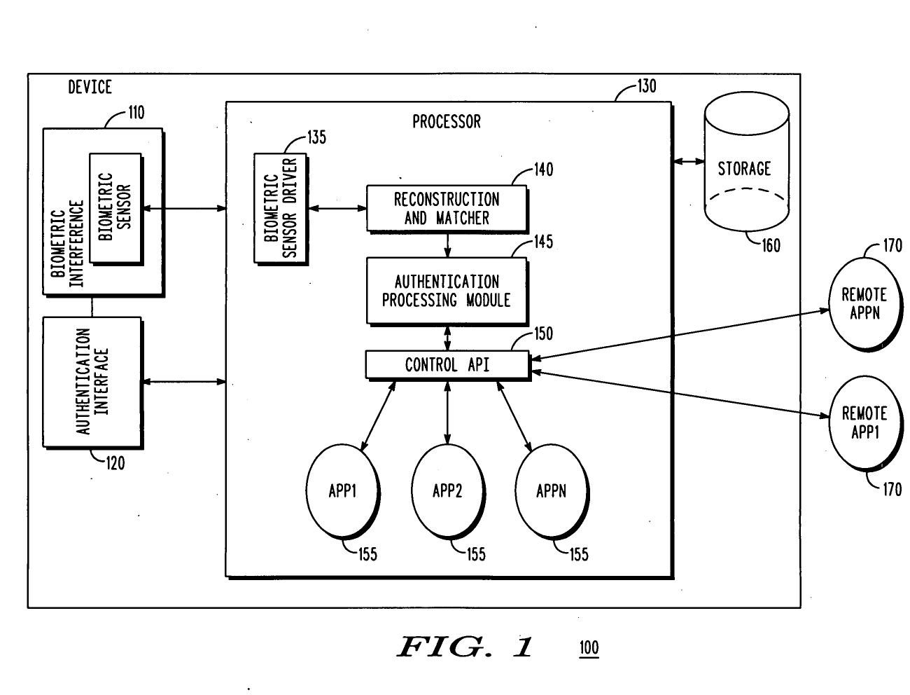

Referring now to the drawings, and in particular FIG. 1, a functional block diagram of a device 100, in accordance with some embodiments is shown. Those skilled in the art, however, will recognize and appreciate that the specifics of this example are merely illustrative of some embodiments and that the teachings set forth herein are applicable in a variety of alternative settings. Other alternative implementations are contemplated and are within the scope of the various teachings described.

In FIG. 1, device 100 has a biometric interface 110, authentication interface 120, processor 130, and storage element 160. Device 100 is capable of biometric authentication of a biometric sample presented by a user to the device. The device may be, for instance, a cellular telephone, a personal digital assistant (PDA), a radio, a laptop computer or other mobile devices, as well as a personal computer (PC), server or enterprise server, having these functional elements. The biometric sample may be a fingerprint sample, an iris or retinal scan, etc., used to identify a biometric characteristic unique to a user. If the biometric sample is a fingerprint sample, the sample may be fingerprint swipe or a fingerprint scan provided by the user at the biometric interface 110.

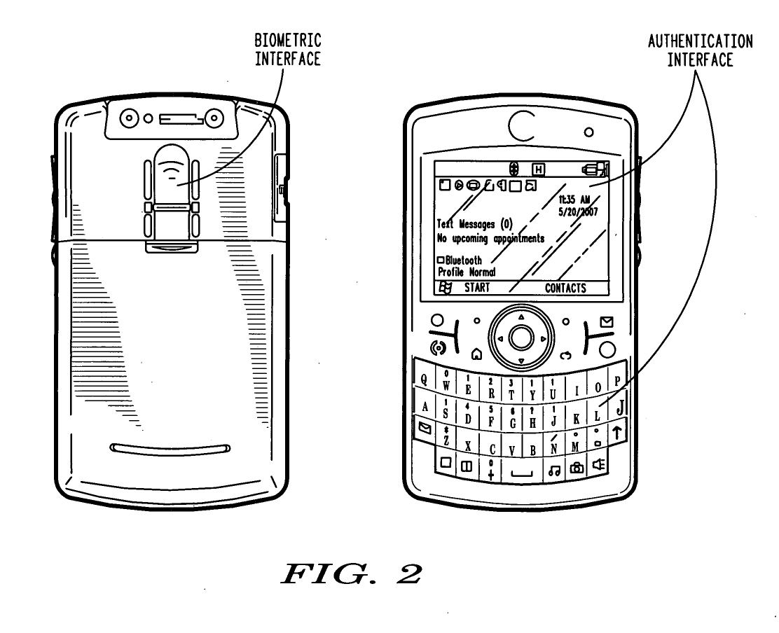

The biometric interface 110 has a biometric sensor capable of receiving a biometric sample of the user; the biometric sample may be a fingerprint (in which case the biometric interface is a fingerprint sensor), an iris scan, or other biometric samples that uniquely identify the user. The biometric interface 110 is in operational communication with the processor 130, as is authentication interface 120, which is operable to interface with the user. An example of a biometric interface 110 is shown by the fingerprint sensor in FIG. 2, which also illustrates a display and keyboard suitable for communicating with the user as an authentication interface.

Within processor 130 is a biometric sensor driver 135 operable to receive the biometric sample provided by the user. Biometric sensor driver 135 is in communication with reconstruction and matcher element 140, which receives the biometric scan or image of the biometric sample and attempts to match it with at least one template unique to the user that is stored in storage element 160. While storage element 160 appears to reside within device 100 it is understood and envisioned that templates may also be stored remotely from the device and downloaded as needed. Such might be the case, for example, where one or more biometric templates associated with the user are stored on the Internet at a website associated with an application the user wishes to use. The application or program may be a security feature such as paypass, password, login, or the like. Reconstruction and matcher element 140 additionally communicates with authentication processing module 145, which has an algorithm based upon the system accuracy using the false reject ratio (FRR) associated with biometric samples provided by the user, as will be described.

A control application programming interface (API) 150 communicates with various applications or programs that the user wishes to access through biometric authentication. As indicated in the drawing, the application(s) may be an application that resides on the device, such as applications APP1, APP2 through APPN 155, or the application(s) may be remote from the device, as in Remote APP1 through APPN 170. Remote applications at a remote location may be accessed by the device over a communication medium, such as applications available on the world wide web (WWW) or Internet.

The processor 130 is operable to compare a biometric sample of the user that is received at the biometric interface to at least one stored template that uniquely identifies the user and thus generate a match score when the biometric sample matches one of the templates stored in storage element 160. The processor compares the match score to a match score threshold value of an application that the user is attempting to access in order to generate match score comparison results. An updated false reject ratio (FRR) for the last N matches of the user can then be calculated. The processor permits the user to access the application when the match score comparison results indicate that the match score is at least equal to the match score threshold value and the updated FRR is less than a FRR threshold value of the application.

When the updated FRR is greater than the FRR threshold value of the application, the processor of the device determines whether a consecutive number of samples for the user has exceeded a sample number threshold, and when the consecutive number of samples has not exceeded the sample number threshold the biometric interface is operable to receive a next biometric sample of the user, which the processor compares to the biometric template(s); otherwise, the processor controls the authentication interface to allow password authentication of the user at authentication interface 120.

Upon the processor comparing a received biometric sample to a quality threshold and further to one or more stored templates, when the biometric sample does not exceed the quality threshold the processor controls the biometric interface to receive a next biometric sample of the user to compare to the template(s) when the consecutive number of samples provided by the user has not exceeded the sample number threshold.

The match score threshold value may be considered a minimum match score of the application that the user wishes to access. When there is a match between the submitted biometric sample and a template(s) but the match score of the match is not at least equal to the match threshold value, the processor 130 further calculates an updated false reject ratio (FRR) for the last N matches of the user and the processor 130 controls the biometric interface 110 to receive a subsequent biometric sample of the user if the user has not exceeded a permissible sample number threshold; otherwise, the processor controls the authentication interface 120 to provide the user with a password authentication interface that allows the user to perform password authentication.

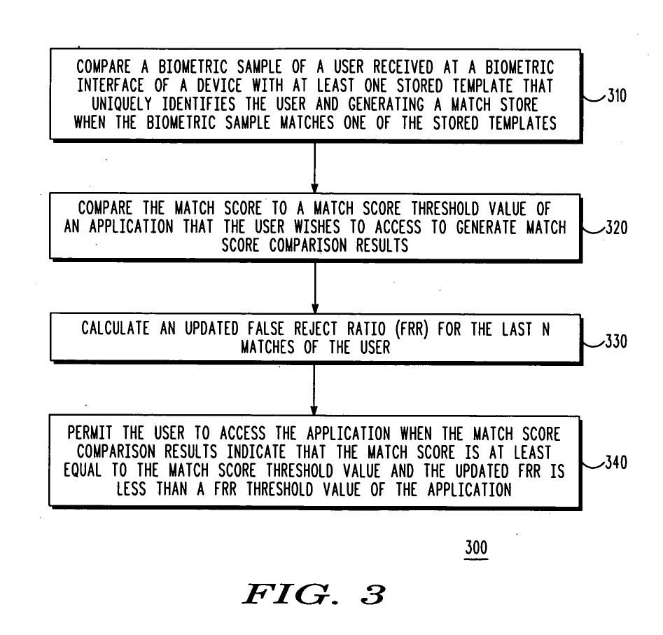

Turning now to FIG. 3, a flowchart 300 of biometric authentication in accordance with various embodiments is illustrated. At Block 310, a biometric sample of a user received at a biometric interface of a device is compared with at least one stored template that uniquely identifies the user and a match score is generated when the biometric sample matches one of the stored templates. At Block 320, the match score generated in Block 310 is compared to a match score threshold value of an application that the user wishes to access in order to generate match score comparison results. Next, an updated FRR of the user is calculated for the last N matches received from the user at Block 330. The user is permitted to access the application at Block 340 when the match score comparison results indicate that the match score is at least equal to the match score threshold value and the updated FRR is less than a FRR threshold value of the application.

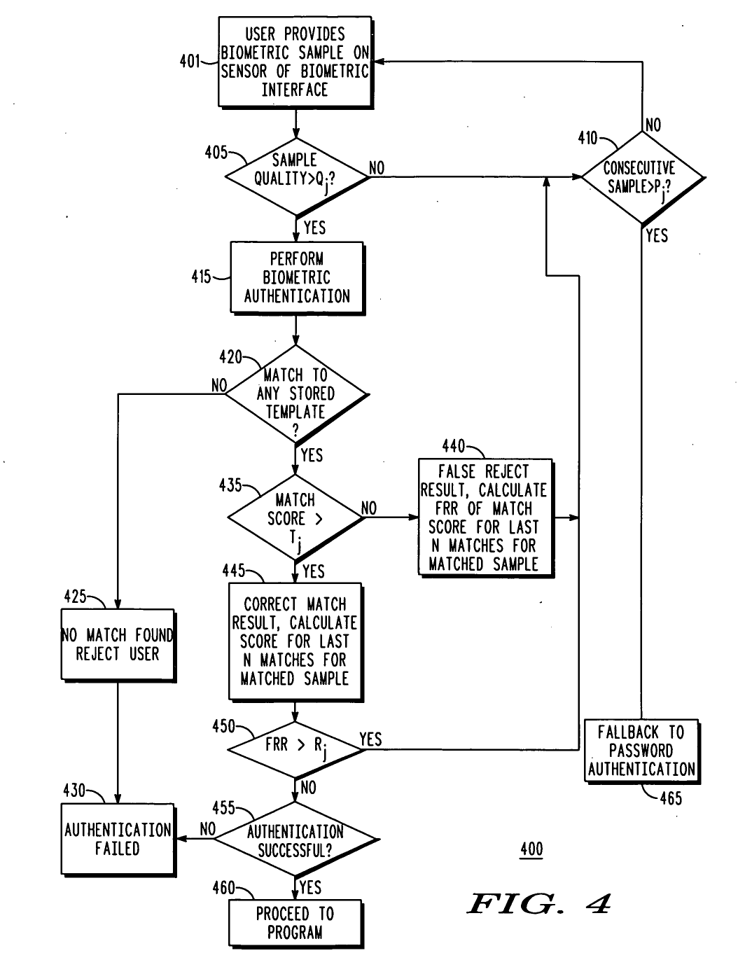

This is further illustrated by biometric authentication flow diagram 400 of FIG. 4 in accordance with various embodiments. Flow diagram 400 is explained within the context of fingerprint biometric authentication for purposes of illustration; the method is not limited to fingerprint biometrics, as has been previously discussed. At Block 401, the user provides a biometric sample on a sensor of the biometric interface. Within the context of the fingerprint biometric authentication example, the user swipes his finger on the fingerprint sensor. At Decision Block 405, the inquiry is whether the biometric sample received has adequate quality at least equal to quality threshold value Qj for a program or application j that the user is trying to access. The quality threshold value Qj can be variable or constant; for simplicity in this example, we assume it to be constant. If no, then this indicates that the biometric sample provided by the user is not of sufficient quality to proceed with biometric authentication. Bad sample quality could be due to a variety of factors, such as lotion on the finger or the finger being cold and thus its fingerprint being more shriveled than normal. The algorithm will direct the user to provide an additional biometric sample if a permissible number of samples, Pj a sample number threshold, has not been exceeded. Thus, at Decision Block 410, the flow returns to Block 401 if the user's number of biometric samples has not exceeded Pj; otherwise, the flow continues to Block 465 where the user is allowed to engage in an alternative authentication method, such as password authentication at a password authentication interface. By reverting to password authentication, frustration of the user will be lessened. At Decision Block 455, the inquiry is whether the password authentication performed at Block 465 is successful. If no, then the authentication process has failed, Block 430. If yes, then the user is allowed to proceed to the program or application he wished to access.

Returning again to Decision Block 405, if the sample quality is sufficient, then the algorithm proceeds to biometric authentication, Block 415. The inquiry at Decision Block 420 is whether there is a match between the biometric sample provided and any stored template. The image that is captured of the user's fingerprint, to continue with the fingerprint example, is matched against enrolled templates unique to the user. If, no, then the user is rejected at Block 425 and biometric authentication has failed for this user, Block 430. If, yes, however, then the match score generated by matching the biometric sample to a template is compared to a match score threshold value Tj at Decision Block 435. The match score threshold value may be dependent on an application, such as an application to allow the user to make a payment, or dependent on the context in which the application is used. In the case of context affecting the match score threshold value, consider that the application could be used in a context requiring a high transaction security, e.g. a high value financial transaction worth millions of dollars, or in a different context requiring a low transaction security, such as a routine, lower amount automatic teller machine (ATM) withdrawal.

If the match score does not exceed Tj, then a false reject result is indicated. An updated FRR for the last N matches of the users is calculated at Block 440. The FRR may be a function of template quality and match score for the last N matches of the user. Thus, the FRR associated with a first sample given by the user would be given as FRR(1)=f(image quality(1), match score) while the FRR associated with a second sample of the same user is given by FRR(2)=f(FRR(1), image quality(2), match score(2)). The FRR of the Nth sample would then be given as FRR(N−1)=f(FRR(N−2), image quality(N), match score(N)). It can be seen that the current FRR value is dependent upon the quality of previous samples. Sample quality data is always being collected and used in the determination of the current FRR in this manner. The flow goes to Block 401 where the user is allowed to provide a consecutive biometric sample if the number of consecutive samples received has not exceeded Pj.

If, however, the match score does exceed Tj, then a correct match result is indicated and an updated FRR for the last N matches of the user is calculated at Block 445, in the manner described above in which ongoing data concerning the sample quality provided by the user is used to determine the updated FRR. An initial FRR value may be calculated based on the first sample, i.e. fingerprint swipe, provided by the user and a look-up table, or it may be calculated during the user enrollment process in which the user enrolls his biometric sample. In calculating the updated FRR, older matches that are older than the N matches are dropped to reflect continuous improvement by the user in providing biometric samples.

The updated FRR is then compared to an FRR threshold value Rj; Rj refers to the FRR needed for the user to be able to access a particular program j. If the updated FRR is greater than Rj, the flow goes to Block 410. If, however, FRR is not greater than Rj, the inquiry at Block 455 is whether authentication is successful. If yes, the user can proceed to the application or program at Block 460. If authentication was not successful, then the biometric authentication process has failed, Block 430. As used herein the parameters FRR, FAR, j, Qj, Pj, Tj, N, and Rj of the biometric authentication algorithm may be set as needed, either by the application j the user is attempting to access, by the issuer/controller of a particular program, such as a credit card company, or at the factory where the application or device is manufactured.

In accordance with various additional embodiments, the security level as reflected in FRR, is dynamically set based at least in part on the presence of one or more context usage override conditions associated with an authentication request by the user for a particular application. A biometric sample of the user is received at a biometric interface of a device as part of a biometric authentication request by the user, wherein the biometric sample is provided by the user in an attempt to access an application, and wherein the biometric sample is characterized by a match score when the biometric sample matches at least one stored template that uniquely identifies the user. The presence of a context usage override condition of the biometric authentication request is detected and a context usage factor is updated based upon the context usage override condition. A biometric recognition threshold required for the user to access the application and indicative of a threshold security level required for biometric authentication is calculated based on the context usage factor. The user is permitted to access the application when the match score of the biometric sample is at least equal to the biometric recognition threshold. Those skilled in the art will realize that the above recognized advantages and other advantages described herein are merely illustrative and are not meant to be a complete rendering of all of the advantages of the various embodiments.

The biometric recognition threshold, then, is capable of being dynamically or adaptively set based on the context in which the authentication request was made. Context includes generic context, application specific context, and historic usage data. A default biometric recognition threshold is dynamically tuned to reflect one or more of these context usage conditions. It is considered that the default biometric recognition threshold is dynamically tuned to reflect generic and/or historical usage and that tuned or updated biometric recognition threshold may be further adapted to reflect application specific context.

Consider a generic usage override condition. Examples of generic usage override condition include a location based condition, a time of day condition, a humidity condition, an ambient light condition, a temperature condition or a motion condition caused by usage of the device, as mentioned above. With regard to a location condition, the calculated biometric recognition threshold may be dependent upon the location in which the user uses the device to access the application. If the device has location based services support (through GPS, WiFi triangulation, cellular triangulation, or the like), this information can be used to determine the security level required to access the application. A back end policy server, or a limited version running on the device, containing relevant location information, can be used to determine the security policy. For example, if the location is a local fast food place, the security level can be set lower. If the location is a high class restaurant, the security can be set higher. Or, with regard to a time of day condition, the calculated biometric recognition threshold may be dependent upon the time of day that the user uses the device to access the application. Furthermore, consider that motion and environmental (e.g. humidity and temperature) conditions can also affect the biometric recognition threshold needed.

Consider the following example, in which a user is detected using the device to pay a transit fare from a near field communication (NFC) terminal at a location in a metro station. The ambient light sensor may detect that the user is underground, and the motion sensor senses quick motions corresponding to the authentication swipe by the user, which may be of poor quality because the user is in a hurry to catch the train. In this specific example, the application may choose to override the default security setting and lower the biometric recognition threshold to allow for better user experience. Setting the biometric recognition threshold lower in this case will allow a lower FRR to be acceptable, resulting in less user frustration that might otherwise result from the poor fingerprint swipe. In this example, the subway payment can be identified from the NFC terminal, the user motion, and the location.

An application specific usage override condition may include a terminal location, a facility in which the terminal is housed, an amount of a financial transaction that affects the biometric recognition threshold, and/or application specific parameters, like a user account type, a user account balance, a transaction type, or a recent activity parameter. It is noted that a terminal may be the device from which the user attempts to access one or more applications.

Consider the following description of the terminal at which the user may attempt access of an application. For the NFC terminal using a short-range wireless communication technology and offering contactless payment to the user, the terminal can define the security required, which may be based on the location of the terminal, the type of facility the terminal is located in, or the amount of the transaction. The terminal can request the security required from a back end policy server, discussed below, with which it communications.

Another example of an application specific usage override condition has to do with the price or amount of a transaction. The security level required to access the application may simply be based on the amount of the transaction. In this case, generally the lower the amount, the lower the relative security level required. The decision can be made by the application on the device, the terminal, or a back end policy server.

It is noted that a policy server or authentication server operating in tandem with the device can provide security requirements based on relevant information. Such information may include a user account type, user account balance; information from the application server such as type of transaction, credit card or debit card transaction, amount of the transaction, recent activities such as fraudulent transaction, very recent frequent and/or large transactions. A back end policy server can provide the definition for security policy based on such relevant information. The policy server can communicate the information to a terminal, in the case of terminal-defined security, directly to the device, or through the application server handling the transaction. Moreover, an authentication server can be used for authentication and policy definition. In this configuration, the biometric sample, such as a finger swipe, may be encrypted and transmitted to the authentication server. The authentication server can perform the authentication (print match) and based on relevant information, decide if the match score provides sufficient security.

A historical usage override condition may be an updated false reject ratio (FRR) for the last N matches of a plurality of biometric samples supplied by the user, as described at length above. The biometric sample of the user received at the biometric interface is compared with the at least one stored template of the user and a match score generated when the biometric sample matches the stored template. The match score is compared to a match score threshold value of the application that the user is attempting to access to generate match score comparison results, and the updated false reject ratio (FRR) for the last N matches of the user is calculated. The user is permitted to access the application when the match score comparison results indicate that the match score is at least equal to the match score threshold value and the updated FRR is less than a FRR threshold value of the application.

Consider as an example a user, who historically never uses the device from midnight until 6 am while asleep, at home where the biometric recognition threshold is low for this location. An attempt to use the device to access an application at 3 am is a historical override usage condition that is contrary to historical usage by the user and could result in the biometric recognition threshold being raised.

Consider further the following ebanking applications with epayment feature. The application may have a default security level regardless of what the purchase is. However, in accordance with the teachings herein, if the payment amount is small, such as lunch at a fast food restaurant or contactless payment for subway fare, the default biometric security level can be dynamically set lower. In the case of a subway payment at an NFC terminal, the user may be in a rush to catch the train and may not provide a good biometric sample, a fingerprint swipe, for example. Conversely, if the purchase is for an expensive diamond ring, the biometric recognition security level should be set higher for a lower FAR. This will help protect the user from fraudulent activities.

The various embodiments described herein provide customized biometric authentication that is based at least in part upon usage history and learning capabilities of a user, thereby addressing shortcomings of past and present biometric authentication techniques and/or mechanisms. Customized levels of security based upon the needed security level of an application may be achieved. User frustration will be less, while maintaining the security level, as reflected in the FRR, needed by a particular application. Customized FRR is based on dynamic updates of ongoing samples provided by a particular user and not on statistic results calculated from stale user samples or a construct independent of the user. This allows the user the flexibility of good sample days and bad sample days while still requiring the user to practice correct sample mechanics. It also is forgiving if the user forgets which biometric sample, such as which finger, is to be used for a particular application.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processor” or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus for biometric authentication described herein. The non-processor circuits may include, but are not limited to, a radio receiver, a radio transmitter, signal drivers, clock circuits, power source circuits, and user input devices. As such, these functions may be interpreted as steps of a method to perform the biometric authentication described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment can be implemented as a computer-readable storage element or medium having computer readable code stored thereon for programming a computer (e.g., comprising a processing device) to perform a method as described and claimed herein. Examples of such computer-readable storage elements include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method of biometric authentication, comprising
comparing a biometric sample of a user received at a biometric interface of a device with at least one stored template that uniquely identifies the user, and generating a match score when the biometric sample matches one of the stored templates;
comparing the match score to a match score threshold value of an application that the user is attempting to access to generate match score comparison results, and calculating an updated false reject ratio (FRR) for the last N matches of the user; and
permitting the user to access the application when the match score comparison results indicate that the match score is at least equal to the match score threshold value and the updated FRR is less than a FRR threshold value of the application.

2. The method of claim 1, when the updated FRR is greater than the FRR threshold value of the application, the method further comprising:
determining whether a consecutive number of biometric samples for the user has exceeded a sample number threshold; and
when the consecutive number of biometric samples has not exceeded the sample number threshold, receiving a next biometric sample of the user at the biometric interface to compare to the at least one template, otherwise performing an alternative authentication method.

3. The method of claim 2, wherein the alternative authentication method comprises the user entering a password.

4. The method of claim 1 further comprising comparing the received biometric sample to a quality threshold, and comparing the biometric sample to the at least one template when the biometric sample exceeds the quality threshold.

5. The method of claim 4 further comprising:
when the biometric sample does not exceed the quality threshold, receiving a next biometric sample of the user at the biometric interface to compare to the at least one template when a consecutive number of biometric samples has not exceeded a sample number threshold.

6. The method of claim 1, wherein the match score threshold value is a minimum match score of the application that the user is attempting to access, and when there is a match but the match score of the match is not at least equal to the match score threshold value, the method further comprising calculating the updated FRR for the last N matches of the user.

7. The method of claim 6 further comprising allowing the user to submit a subsequent biometric sample at the biometric interface if the user has not exceeded a sample number threshold, otherwise providing the user with a password authentication interface to perform password authentication.

8. The method of claim 1, wherein the biometric sample is a fingerprint sample.

9. The method of claim 1, further comprising:
detecting the presence of a context usage override condition of the biometric authentication;
updating a context usage factor based upon the context usage override condition;
calculating the match score threshold required for the user to access the application based on the updated context usage factor, wherein the match score threshold determines a threshold security level required for the biometric authentication.

10. The method of claim 9, wherein the context usage override condition is a historical usage override condition that comprises the updated FRR for the last N matches the user.

11. A device capable of biometric authentication, comprising:
a processor;
a biometric interface operable to receive a biometric sample of a user and in operational communication with the processor;
a password authentication interface operable to interface with the user of the device and in operational communication with the processor;
wherein the processor compares the biometric sample of the user received at the biometric interface to a quality threshold, and when the biometric sample exceeds the quality threshold, the processor compares the biometric sample of the user received at the biometric interface with at least one stored template that uniquely identifies the user and generates a match score when the biometric sample matches one of the stored templates;
wherein the processor compares the match score to a match score threshold value of an application that the user is attempting to access to generate match score comparison results, and calculates an updated false reject ratio (FRR) for the last N matches of the user; and
wherein the processor permits the user to access the application when the match score comparison results indicate that the match score is at least equal to the match score threshold value and the updated FRR is less than a FRR threshold value of the application;
wherein when the match score of the match is not at least equal to the match score threshold value, the processor further controls the biometric interface to receive a next biometric sample of the user if the user has not exceeded a sample number threshold, otherwise the processor controls the password authentication interface to accept a user password to perform password authentication;
wherein when the biometric sample does not exceed the quality threshold; the processor controls the biometric interface to receive the next biometric sample of the user if the user has not exceeded the sample number threshold, otherwise the processor controls the password authentication interface to accept the user password to perform password authentication;
wherein when the updated FRR is greater than the FRR threshold value of the application and if the user has not exceeded the sample number threshold, the processor controls the biometric interface to receive the next biometric sample of the user, and the processor compares the next biometric sample to the at least one template, otherwise the processor controls the password authentication interface to accept the user password to perform password authentication.

12. The device of claim 11, wherein the device is one of a laptop computer, a personal computer, an enterprise service, a cellular telephone, a personal digital assistant, or a radio having the biometric interface.

13. The device of claim 11, wherein the device further comprises a storage element coupled to the processor, and the one or more user templates are stored in the storage element.

14. The device of claim 11, wherein the biometric interface comprises a fingerprint sensor.

15. The device of 14, wherein the biometric sample is at least one of a fingerprint swipe provided by the user at the biometric interface or a fingerprint scan provided by the user at the biometric interface.

16. A computer-readable storage element having computer readable code stored thereon for programming a computer to perform a method for biometric authentication, the method comprising:
comparing a biometric sample of a user received at a biometric interface of a device with at least one stored template that uniquely identifies the user, and generating a match score when the biometric sample matches one of the stored templates;
comparing the match score to a match score threshold value of an application that the user is attempting to access to generate match score comparison results, and calculating an updated false reject ratio (FRR) for the last N matches of the user; and
permitting the user to access the application when the match score comparison results indicate that the match score is at least equal to the match score threshold value and the updated FRR is less than a FRR threshold value of the application.

17. The computer-readable storage element of claim 16, when the updated FRR is greater than the FRR threshold value of the application, the method further comprising:
determining whether a consecutive number of samples for the user has exceeded a sample number threshold; and
when the consecutive number of samples has not exceeded the sample number threshold receiving a next biometric sample of the user at the biometric interface to compare to the at least one template, otherwise performing an alternative authentication method.

18. The computer-readable storage element of claim 16, the method further comprising comparing the received biometric sample to a quality threshold, comparing the biometric sample to the at least one template when the biometric sample exceeds the quality threshold, and when the biometric sample does not exceed the quality threshold receiving a next biometric sample of the user at the biometric interface to compare to the at least one template when the consecutive number of samples has not exceeded the sample number threshold.

19. The computer-readable storage element of claim 16, wherein when there is no indication of the match between the biometric sample and a template, communicating to the user that biometric authentication has failed.

20. The computer-readable storage element of claim 16, wherein the match score threshold value is a minimum match score of the application that the user is attempting to access and when there is a match but the match score of the match is not at least equal to the match threshold value, the method further comprising calculating the updated FRR for the last N matches of the user and allowing the user to submit a subsequent biometric sample at the biometric interface if the user has not exceeded a sample number threshold, otherwise providing the user with a password authentication interface to perform password authentication.
